(19) United States
(12) Patent Application Publication
(10) Pub. No.: US 2014/0143840 A1
(43) Pub. Date: May 22, 2014

(54) APPARATUS AND METHOD FOR MANAGING ACCESS TO DEVICES OF A VISION SYSTEM

(71) Applicant: Cognex Corporation, Natick, MA (US)

(72) Inventors: Michael R. Miller, Wind Lake, WI (US); Krisztian Gyuris, Tarnok (HU); Attila Robert Vanca, Budapest (HU)

(73) Assignee: Cognex Corporation, Natick, MA (US)

(21) Appl. No.: 14/055,958

(22) Filed: Oct. 17, 2013

Related U.S. Application Data
(60) Provisional application No. 61/727,145, filed on Nov. 16, 2012.

(51) Int. Cl. H04L 29/06

(52) U.S. Cl. CPC H04L 63/08
USPC 726/4

(57) ABSTRACT

The authority of a user seeking access to a vision system is authenticated by a directory server connected to a plurality of cameras. The directory server stores a device directory. When the user requests access to a given camera, a location of an identifier of the given camera in the device directory is determined. From data related to that location, a decision is made whether the user is associated with the given camera. If the user is associated with the given camera, a user access level linked with the user and the given camera is retrieved from the directory server. The user access level identifies a set of privileges corresponding to functions that the user is permitted to perform on the given camera. The user is then permitted to exercise that set of privileges on the given camera.

### CROSS-REFERENCE TO RELATED APPLICATIONS

This application claims benefit of U.S. Provisional Patent Application No. 61/727,145 filed on Nov. 16, 2012.

### STATEMENT REGARDING FEDERALLY SPONSORED RESEARCH OR DEVELOPMENT

Not Applicable

### BACKGROUND OF THE INVENTION

1. Field of the Invention

The present invention relates to machine vision systems having a plurality of configurable cameras, and more particularly to techniques by which users are granted different levels of access to configure the operation of each camera.

2. Description of the Related Art

Computerized vision systems are commonly used in factory automation environments. For example, numerous cameras can be placed along an assembly line to produce images of workpieces. Each image is analyzed by a computer attached to the associated camera to detect features and characteristics of each workpiece. The data acquired from such analysis are employed to control equipment along the assembly line that processes the workpieces. A typical factory can have several assembly lines, thereby having a large total number of cameras that require configuration and control.

Each camera and an associated image processor are user programmable to perform a wide variety of machine vision functions. For example, the machine vision system can use products from the In-Sight® series marketed by the Cognex Corporation of Natick, Mass., USA. The cameras can be connected to a communication network so that personnel in a factory are able to configure the operation of each camera from one or more computer workstations.

Heretofore, the identity of each user having configuration authority had to be stored separately at each camera along with a specification of the types of functions that the particular person was allowed to perform on that camera. For example, some users are only allowed to read the configuration of a given camera, whereas other users are permitted to change the configuration of a specific camera. This arrangement meant that when a new user required access to a several cameras, such as all the cameras along one assembly line, each of those cameras had to be individually accessed by a supervisor, who then created the profile on each camera for the new user. This was a very time consuming task, even though the same user profile was created for all those cameras.

As a consequence, it is desirable to simplify the management of a large number of cameras at a facility.

### SUMMARY OF THE INVENTION

An apparatus is provided for authenticating the authority of each of a plurality of users to access a vision system. The vision system includes a communication network to which a plurality of cameras and a directory server are connected. The a directory server stores information for each user, which define which of the plurality of cameras can be accessed by a particular user and a specification of one or more functions which the particular user is permitted perform at each camera that can be accessed.

The directory server is configured to respond to a given user seeking access to a given camera by determining from the stored information whether the given user can access the given camera. If so, the directory server communicates to the given camera, a designation of the one or more functions permitted to be performed by the given user. Thus the user authorization information is stored in a shared directory server that is available to all the cameras in the vision system.

With this authentication technique, the same user can be permitted to perform different sets of functions on different cameras.

Also, multiple cameras can be placed into a group with one or more users associated with that group and with each user individually linked to a specification of the functions which that user is able to perform on every camera in the group. This enables a single function specification for a given user to be associated with multiple cameras.

In one embodiment, the information in the directory server contains identifications of each of a plurality of users and identifications of each of a plurality of cameras. The stored information also includes an arrangement of associations between each of the plurality of users with at least one of the cameras and a specification of a user access level for each association. For each user access level, a set of privileges is provided defining the functions which a user is permitted to perform at a camera.

The process of authenticating a user can involve the user requesting access to the camera. In response to that request, an identification of the camera in a device directory stored in the directory server is located. From the location of the identification of the camera in the device directory, a determination is made whether the user is associated which the camera. If that is true, data are retrieved from the directory server that specify a set of privileges defining functions which the user is permitted to perform for the camera.

### BRIEF DESCRIPTION OF THE DRAWINGS

FIG. 1 illustrates an exemplary vision system installed in a factory;

FIG. 2 depicts the structure of a directory containing information related to the vision system, the devices thereon, and the users thereof;

FIG. 3 shows an example of entries in a subdirectory of the users;

FIG. 4 illustrates hierarchical organization of an exemplary subdirectory of the devices on the vision system;

FIG. 5 shows an example of entries in a user access level subdirectory;

FIG. 6 depicts a hierarchical organization of an exemplary privileges subdirectory;

FIG. 7 is a flowchart of a process for is authenticating the authority of a given user to access a particular camera of the vision system; and

FIG. 8 is a flowchart of a process for creating a table of emergency users.

### DETAILED DESCRIPTION OF THE INVENTION

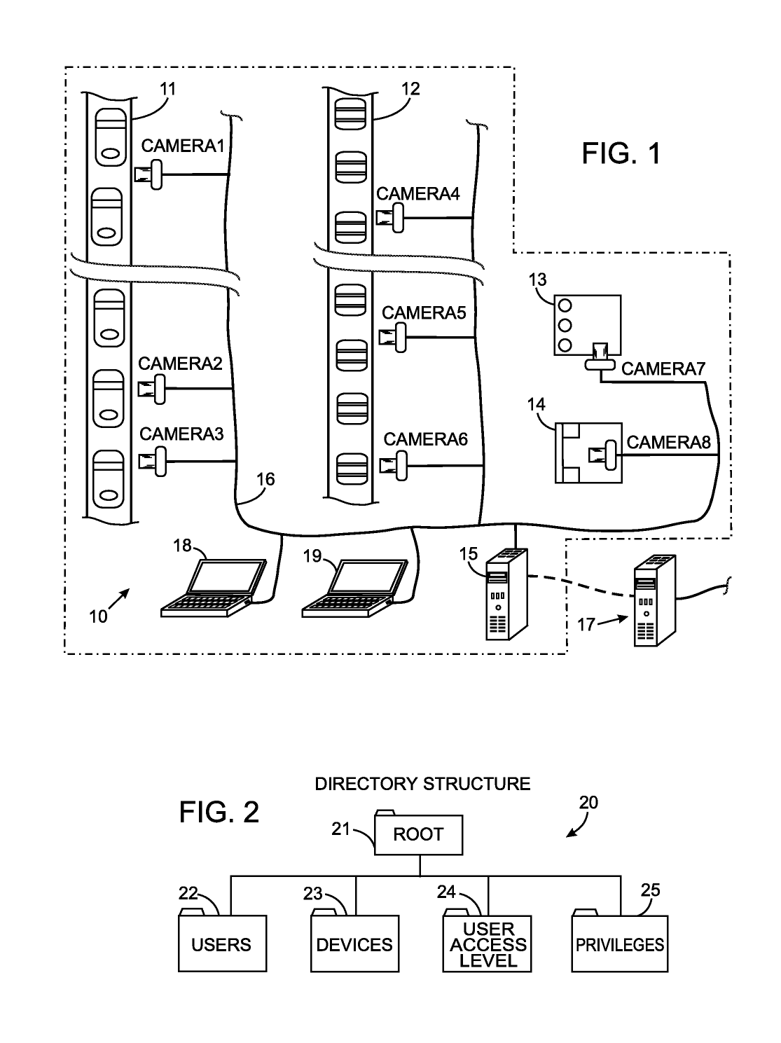

With initial reference to FIG. 1, a vision system 10 is installed in a factory that has a first assembly line 11, a second assembly line 12, and two individual pieces of production equipment 13 and 14. The machine vision system has a plurality of cameras with CAMERA1, CAMERA2, and CAMERA3 associated with the first assembly line 11 to view items being manufactured and to control devices located along that assembly line. Similarly, CAMERA4, CAMERA5, and CAMERA6 are positioned adjacent the second assembly line 12 to create images for analysis while processing other objects being produced on that assembly line. The other two pieces of production equipment 13 and 14 have separate cameras, CAMERA7 and CAMERA8, respectively.

The term “camera” and the graphical symbol in FIG. 1 may correspond not only the camera, but also a processor associated with the camera that is programmed to perform user defined image analysis functions on the image produced by the camera and report the results to controllers for the associated assembly line or piece of production equipment.

The various cameras are connected to a communication network 16 and are assigned individual addresses on that network. A directory server 15, also connected to the communication network 16, is able to exchange messages containing commands and data with each of the cameras. A pair of user workstations 18 and 19 are connected to the communication network 16 and exchange messages with the cameras and the directory server 15. The workstations 18 and 19 are computers that enable personnel at the factory, referred to herein as “users”, to install, configure, and control the operation of various devices of the vision system 10, such as the cameras and the directory server.

The directory server 15 executes software that governs the exchange of messages over the communication network 16. Note that the communication network 16 is not connected to devices or systems, such as the Internet, that are external to the factory. Therefore, the directory server 15 has network administration software which provides network security by functioning as the certificate authority for the communication network 16. The directory server 15 has a site certificate for the facility. The computer that serves as the directory server 15 is assigned a unique server certificate.

A server certificate also must be created for each camera, however, the cameras do not have the capability to create a server certificate. It is undesirable to have the private key for the certificate authority located on the cameras. As a result, the directory server is the only location for the certificate authority private key that is used to create the camera certificates. By creating the certificates at a single location, the network security can be controlled and managed by authorized users.

Therefore, when a given camera is initially connected to the communication network 16 and is being configured, that camera requests a site certificate from the certificate authority operating on the directory server 15. A similar request for a new certificate is made if the network address of an existing camera changes. In both situations, the request is made through an unsecure anonymous connection to a standard lightweight directory access protocol (LDAP). An internal password is stored in the memory of each camera by the manufacturer and the camera uses that password to authenticate the LDAP on the directory server 15. Once the camera has the directory site certificate, the camera can now establish secure communications to the server. Thereafter, all server certificates for both the directory server and the cameras use this site certificate to establish the trust relationship when server clients connect based on the established site certificate in each client (e.g., camera or workstation).

After that, the same communication mechanism enables the camera to retrieve its server certificate from the directory server by now using a secure SSL connection to the LDAP. Additionally, the certificate authority software on the directory server 15 can limit access so that only the specific camera is allowed to read the server certificate. This process for issuing and managing server certificates for the communication network 16 is controlled entirely within the vision system 10 without any connection to an external authority, such as via the Internet.

After a camera has been physically connected to the network 16 and issued a server certificate, its identity must be added to a system directory 20 stored in the memory of the directory server 15. The system directory contains information that is used by a directory program executed on the directory server 15 to authorize which authenticated users are allowed to access which cameras, a separate level of that access, and the operating functions (known as “privileges”) that an allowed user is permitted to perform for a given camera. The system directory has a hierarchical data configuration similar to that of the directory structure for Microsoft Outlook.

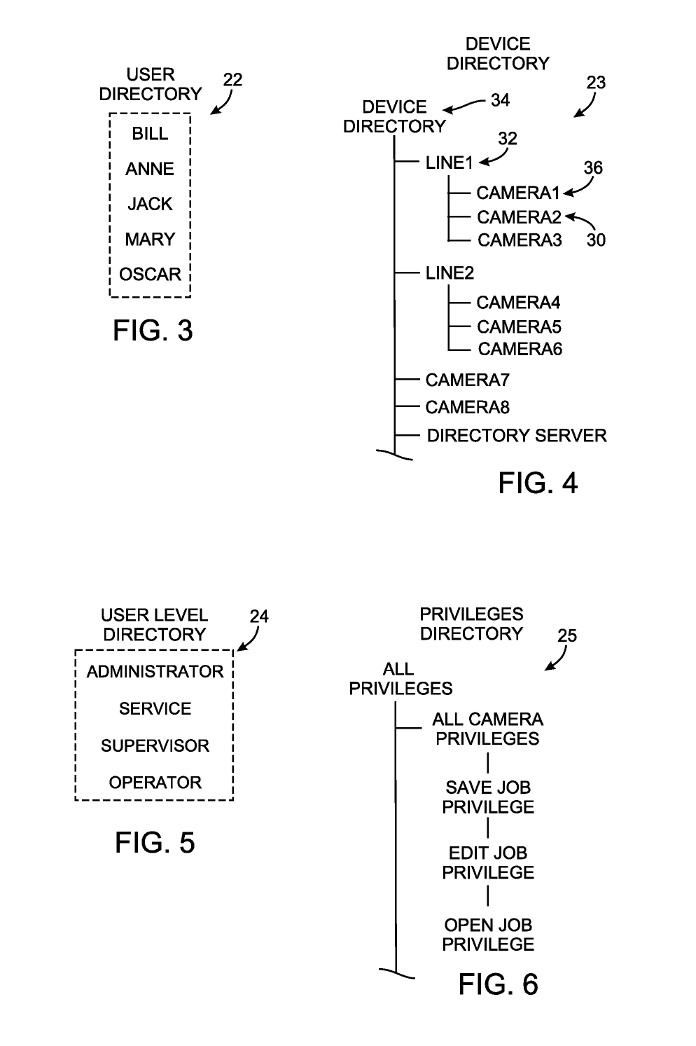

With reference to FIG. 2, the system directory 20 within the directory server 15 is identified in the root directory 21 and has four primary folders or subdirectories 22, 23, 24, and 25. The first primary folder, is also referred to as user directory 22, contains a list of the identities of all the users who are authorized to access one or more cameras to either read the camera configuration or modify the configuration. FIG. 3 illustrates the structure of the user directory 22 as a list of user identifiers. The user identifiers can have any one of several commonly employed forms, such as the person's name, employee number, or other identifier that is unique to the particular person.

Referring to FIG. 4, the system directory 20 also contains a device directory 23 listing all the cameras and other devices that are connected to the communication network 16. A particular camera, such as CAMERA7, can be listed individually in the directory or, in the case of CAMERA2, can be placed into a group with other cameras. For the exemplary vision system 10, separate camera groups have been defined for each of the first and second assembly lines 11 and 12. Alternatively, other groupings can be defined, such as for the cameras in a particular building of a manufacturing campus or for the cameras associated with the different pieces of equipment used to produce a particular product. The groups in the device directory 23 are created by an administrator of the vision system 10 or the communication network 16.

The device directory 23 in FIG. 4, has a hierarchical configuration with a top level referred to as the “Device Directory” level that includes all the devices connected to the communication network 16. Depending from the Device Directory level is a first group defined for the first assembly line 11 (LINED that in turn has a dependent sublevel for each one of CAMERA1, CAMERA2, and CAMERA3. Another group is defined for the second assembly line 12 (LINE2) with a dependent sublevel for each one of CAMERA4, CAMERA5, and CAMERA6. Because CAMERA7 and CAMERA8 are each associated with individual pieces of manufacturing equipment 13 and 14, those cameras are listed in separate levels directly depending from the Device Directory level and are not placed in a group with other cameras, except for being part of the device universe.

FIG. 5 depicts the user access level directory 24, which lists various categories of operational authority with respect to the cameras in the vision system 10. For example, this directory contains an Operator user access level for people who are associated with a section of an assembly line that has one or more cameras or who are an operator of an individual piece of equipment 13 or 14. Other user access categories include a Supervisor level for people who can be responsible for an entire assembly line or an area of the factory, a Service level for technicians who require access to perform maintenance and repair functions on one or more of the cameras, and an Administrator level for individuals who are responsible for managing the entire vision system 10 or the communication network 16. It should be understood that other user access levels can be defined for a particular application of the present machine vision management concept.

Each of the different user access levels has one or more privileges associated therewith. The privileges define functions that can be performed at each of the cameras and are listed in the privileges directory 25 depicted in FIG. 6. In should be understood this privilege directory is exemplary and privileges for other functions can be defined. Therefore, associating one or more privileges with a particular user access level defines the functions that users linked to that user access level are permitted to perform on particular cameras. For example, the Operator user access level can be associated with the Open Job Privilege that enables users with that level of authority to view the configuration of a particular camera, but those users can not change or store a configuration. The Supervisor user access level can be associated with the All Camera Privileges level in the privilege directory 25 to enable individual users with that level of authority to not only view the camera configuration, but also change and store a new configuration for the associated cameras. The Administrator user access level can be associated with the All Privileges level in the privileges directory 25 giving users with that level of authority complete access to all functions which can be performed for any device on the vision system 10.

The combined information contained in the four subdirectories 22-25 specify the people who can access a particular camera and, for those people, the level of their access authority. This is accomplished by associating each particular user with either an individual camera or a group of cameras defined by the various levels in the device directory 23 and specifying the user access level for that camera association. A particular user can be assigned different users levels for different cameras or groups of camera. For example, user Bill can be directly associated CAMERA2 in the device directory 23 and for that association instance given Supervisor user access level authority. Thus with respect to CAMERA2, Bill is able to perform all the privileges associated with that user authority, such as viewing the camera configuration, editing the configuration and image processing, and saving the altered configuration for CAMERA2. In addition, user Bill can also be associated with the device directory level for LINE1 and given Operator level authority for that group of cameras. That Operator level authority allows Bill to view the configuration of CAMERA1 and CAMERA3, while retaining Supervisor level authority for CAMERA2. Thus, the same user, Bill, has different user privileges to perform various functions on discrete cameras in the machine vision system 10. In the case where a user is associated with a particular group of cameras, the granted operating privileges apply to all the cameras in that group, unless the user also is directly associated with an individual camera (e.g. for Bill and CAMERA2) in that group and given a different user access level authority. The same user, e.g., Bill, also can be associated with another camera, such as CAMERA7, in the device directory 23 and assigned a user access level for that camera association. In this manner, a user can be granted different levels of functional authority depending upon the particular camera to which that user accesses.

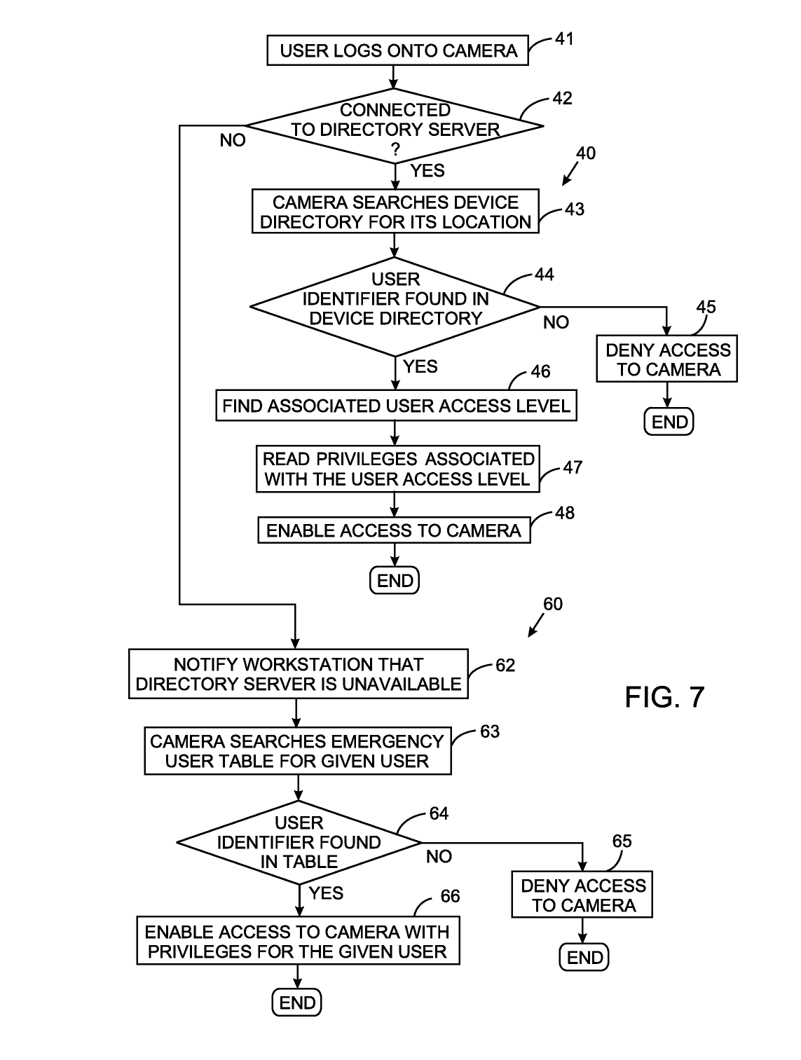

With additional reference to FIG. 7, a given user logged onto one of the workstations 18 or 19 at step 41 is able to address a particular camera (e.g., CAMERA2) on the communication network 16 in order to read or edit the configuration of the camera and the related image processing. The camera responds to being addressed by requesting user information from the directory server 15. Specifically, the request sends the camera's network identifier and the given user's identifier to the directory server. At step 42, the camera makes a determination whether the directory server 15 is on-line and functioning, in which case the normal user authentication process 40 begins at step 43.

The authorization software executed by the directory server 15 utilizes the camera network identifier and the user identifier to determine whether the given user is authorized to access the designated camera. If so, the privileges to be granted to that user are ascertained from the data stored in the system directory 20. In particular, the authorization software searches to find the designated camera's location in the device directory 23, at step 43. For example, CAMERA2 will be found in the LINE1 group. The device directory entry 30 for CAMERA2 then is examined at step 45 to determine whether the given user seeking access is listed in direct association with that device directory location for CAMERA2. If that is true, the authorization software obtains the user access level that is indicated for the designated user in the device directory entry 30 for CAMERA2.

This begins a permission path through the system directory 20. That is, the camera's identifier determines an entry point in the device directory 23 with the identifier of the given user and that person's user access level being associated with that directory entry location.

The authorization software being executed by the directory server 15, advances to step 46 and accesses the user access level directory 24 (FIG. 5) to find an entry for the designated user access level. That user access level directory entry in turn is associated with a level in the privileges directory 25 (FIG. 6) specifying the nature of the privileges, or functions, that are permitted to be performed on the camera being accessed by the particular user (step 47). A designation of the permitted privileges are communicated from the directory server 15 to the specific (e.g. CAMERA2) and at step 48 that camera then grants access to the given user and enables that person to perform the functions specified by the designated privileges. The given user, however, is prevented from performing other privileges that have not been designated.

In another situation, if the identifier of the given user seeking access is not found directly associated with the device level directory entry for the specified camera (e.g., entry 30 for CAMERA2), the search moves up to the next higher directory level in the directory hierarchy chain containing that camera. For CAMERA2, the next higher device directory level 32 is for the LINE1 camera group (see FIG. 4). The authorization software now inspects the user identifiers associated with the LINE1 directory level 32 in the device directory 23 to determine whether the given user is associated therewith. If that association is found, the user access level associated with the given user in that entry is read and then used to retrieve a designation of the related set of privileges from the privileges directory 25.

The related set of privileges for the given user associated with the LINE1 group level 32 applies to all the devices in the directory underneath that level, i.e., CAMERA1, CAMERA2, and CAMERA3. In this manner, a single entry in the device directory 23 grants a user authority to access multiple devices and defines the level of access permitted for that group of devices. The present centralized authorization technique does not require individual entries for a given operator be associated directly with each camera that the person is authorized to access, i.e. associate the given user with the device level entry for every one of those cameras.

It should be understood if the device directory search fails to find the given user associated with the LINE1 group level 32 in FIG. 4, the search moves up to the next higher directory level which in this example is the Device Universe level 34, in an effort to locate an entry for the given user. That process repeats until reaching the uppermost level in the device directory 23. If an entry for the given user still is not found at the uppermost device directory level, the directory server 15 sends a message informing the given camera of that failure. The camera responds to that message by denying the given user access, at step 45.

The present authorization technique also enables the same user to have distinct user access levels for different cameras by that user being identified at multiple locations in the device directory 23. For example, the given user can have broad Supervisor level access for a particular camera, e.g. CAMERA2, but only have Operator level access for CAMERA1 and CAMERA3. In this case, a designation of the given user with a Supervisor user access level indication is associated directly with the location for CAMERA2 at device directory level 36. At the LINE1 group directory level 32, there is another designation of that given user, except with an indication of the Operator user access level. Thus, the same user can have Supervisor level access and the related privileges to control CAMERA1 and CAMERA3.

In this latter example, when the given user seeks access to CAMERA2, the authorization software commences the process at the device directory level 36 for that camera and will find the entry for the given user directly associated with that device level entry. As a result, the authorization software searches no farther in the device directory 23 in order to determine the privileges to grant. Alternatively, when the given user seeks access to CAMERA1, for example, the authorization software does not find an entry for the given user directly associated with the location of the identifier for CAMERA1 at device directory level 36. As a consequence, the search moves to the next higher directory level, in this case the LINE1 group level 32. At this group, the authorization software will find an associated entry for the given user specifying the Operator user access level, which then is used to grant the given user access to CAMERA1.

Furthermore, the same user can have an entry in the device directory 23 at the Device Universe level 34 granting that person a specified user access level for all the other devices on the vision system. As a result, a given user may have multiple access levels for different devices in the vision system 10. This creates multiple permission paths through the system directory 20 with access to a particular camera being defined by the path at the lowest or most specific level in the device directory that contains the particular camera in association with the given user.

In some installations as shown by the dashed line in FIG. 1, the vision system 10 optionally can be integrated with the company's primary IT network 17 within the factory, Wherein the primary IT network 17 uses another directory management system, such as Microsoft Active Directory or IBM Tivoli Directory Server, for example, which enables users to have a single password and password policy for both networks. The user credentials are validated on the primary IT network Active Directory or other directory service. Not all users of the vision system directory server 15 can be represented on the primary IT network so the company must be able to choose which users are authenticated with the external server. In this latter installation, the vision system authorization structure still resides on vision system directory server 15.

There can be times when the directory server 15 is unavailable or otherwise not functioning when a user attempts to access a camera. In that case, the normal user authentication process 40 cannot be performed. This could result in the assembly line or other piece of equipment associated with that camera having to be shut down until the directory server 15 is available. To avoid that condition, the present vision system 10 stores an emergency user table in the memory of each camera to define certain users and their user privileges for that particular camera.

For each camera in the vision system 10, a separate emergency user table can be created in the directory server 15. A process similar to that which is used to identify normal users and their privileges in the user directory 22 is employed to create the emergency user table. Different persons can be authorized to access a specific camera when the directory server 15 is unavailable than during normal operating conditions.

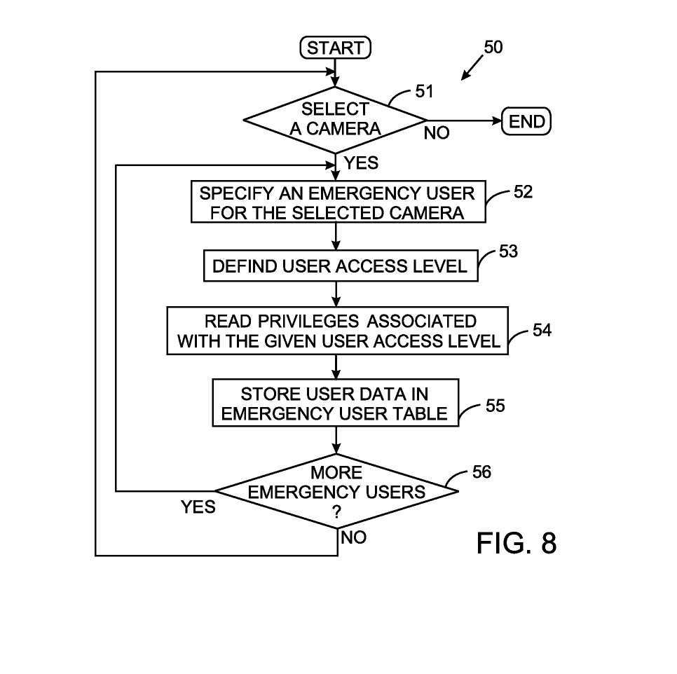

The tables of emergency users for the cameras are created by the process 50 depicted by the flow chart in FIG. 8. The process commences at step 51 where a system operator creating a table selects a camera of the vision system 10. Then at step 52, an emergency user for the given camera is specified either by choosing a person from the list of previously defined users or defining a new user. Next at step 53, a user access level is assigned to that user, which can be a different user access level than assigned to the same user under normal conditions. That user access level is employed at step 54 to obtain the associated privileges specified in the privileges directory 25. The user identifier and the associated privileges form an entry for the emergency user table of the selected camera. That entry then is stored in an emergency user table in the directory server 15 at step 55. A determination is made at step 56, whether more emergency users should be designated for the selected camera. If so, the process repeats steps 52-55 for another user. When all the emergency users have been specified for the selected camera, the process branches from step 56 back to step 51 so that the system operator can create or modify an emergency user table of another camera. In this manner, separate emergency user tables can be created for each camera of the vision system 10, however those tables are optional and can not be created for every camera.

Occasionally, such as whenever a user normally accesses a camera or once a day, the table of emergency users for that camera is transferred from the directory server 15 via the communication network 16 into the memory of the camera. The result is a table stored in each camera that specifies a group of emergency users and their operating privileges for use in the event that the directory server 15 is unavailable.

Thereafter, when a given user attempts to access a particular camera at step 42 in FIG. 7, if that camera cannot communicate with the directory server 15, the logon process branches at step 42 to an emergency user authentication process 60, which commences at step 62. At that time, the camera sends a message to the workstation 18 or 19 from which the given user is attempting access. The workstation displays that message to indicate to the given user that the directory server 15 is unavailable. The emergency user authentication process 60 then advances to step 63 at which the camera searches its emergency user table for the identifier of the user who is seeking access. If at step 64 the user is not found, the process branches to step 65 at which access to the camera is denied and the process terminates. If the user is found in the emergency user table at step 64, the process branches to step 66 at which access to the camera is enabled with the privileges associated with that given user in the emergency user table.

This emergency user continues to have access to the camera until that person logs off, even if operation of the directory server 15 is restored in the interim. However, once the operation of the directory server is restored, any person subsequently attempting to access a camera on the system will be authenticated using the normal user authentication process 40 defined by steps 43-48.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An apparatus for authenticating authority of each of a plurality of users to access a vision system, wherein the vision system includes a plurality of cameras connected to a communication network, said apparatus comprising:
a directory server connected to the communication network and storing data for each of the plurality of users that define which of the plurality of cameras can be accessed and a specification of one or more functions permitted to be performed for each camera that can be accessed;
wherein the directory server is configured to respond to a given user seeking access to a given camera by determining from the data whether that given user can access the given camera, and if so, communicate to the given camera, a designation of the one or more functions permitted to be performed by the given user.

2. The apparatus as recited in claim 1 wherein the data stored in the directory server for one given user specifies a first set of functions permitted to be performed for a first camera, and specifies a second set of functions permitted to be performed for a second camera.

3. The apparatus as recited in claim 1 wherein the data stored in the directory server associates one given user with a group of several cameras in the plurality of cameras, and specifies a common set of functions permitted to be performed for each camera in the group.

4. The apparatus as recited in claim 1 wherein the data stored in the directory server for one given user:
defines a first relationship with a first camera in the plurality of cameras and with a first set of functions permitted to be performed on the first camera; and
defines a second relationship with a second camera in the plurality of cameras and with a second set of functions permitted to be performed on the first camera.

5. The apparatus as recited in claim 4 wherein the first set of functions and the second set of functions are different.

6. The apparatus as recited in claim 1 wherein the data stored in the directory server comprises:
information identifying each of the plurality of users;
information identifying each of the plurality of cameras;
data specifying separately for each of the plurality of users, an association with at least one of the plurality of cameras;
a specification of a user access level for each association; and
for each user access level, a specification of a set of privileges identifying functions permitted to be performed.

7. A method for authenticating authority of a user to access to a vision system, wherein the vision system includes a first plurality of cameras and a directory server operably connected to exchange messages over a communication network, said method comprising:
the user requesting access to a given camera;
finding a location of an identification of the given camera in a device directory stored in the directory server;
determining from the location in the device directory, whether the user is associated which the given camera;
if the user is associated which the given camera, retrieving from the directory server, data specifying a set of privileges defining functions that the user is permitted to perform for the given camera.

8. The method as recited in claim 7 wherein retrieving from the directory server, data specifying a set of privileges comprises:
identifying a user access level associated with the user and the given camera; and
employing the user access level to identify the set of privileges.
